(19) United States
(12) Patent Application Publication
(10) Pub. No.: US 2007/0038466 A1
(43) Pub. Date: Feb. 15, 2007

(54) Electronic sweepstakes entry distribution system

(75) Inventors: Clifton E. Lind, Austin, TX (US); Jefferson C. Lind, Austin, TX (US)

Correspondence Address: THE CULBERTSON GROUP, P.C., 1114 LOST CREEK BLVD., SUITE 420, AUSTIN, TX, 78746, US

(73) Assignee: Multimedia Games, Inc.

(21) Appl. No.: 11/201,487

(22) Filed: Aug. 11, 2005

(51) Int. Cl. G06Q 99/00

(52) U.S. Cl. 705/1

(57) ABSTRACT

A method of distributing sweepstakes entries includes associating a product with a user account. The product may be a product such as Internet access time, calling card minutes, gift card credit, other types of store credit, or any other type of product. One or more sweepstakes entries are associated the user account based at least in part upon the value of the product that has been associated with the user account. A user ticket is dispensed to a user correlated with the user account. This user ticket is associated with the product through information recorded on the user ticket, and is also printed with a respective indicia for each respective sweepstakes entry associated with the user account. A user receiving the user ticket may see their sweepstakes entry results at a display terminal that causes the results to be displayed in an entertaining fashion.

### TECHNICAL FIELD OF THE INVENTION

The present invention relates to an electronic sweepstakes system utilizing a physical user ticket to distribute entries in a sweepstakes game conducted in connection with the sale of a product. The invention includes a method for distributing sweepstakes entries and revealing sweepstakes entry results, and also includes a sweepstakes entry distribution system and program product.

### BACKGROUND OF THE INVENTION

Sweepstakes games are commonly used to promote the sale of various products or to encourage charitable donations. Generally, a sweepstakes game entry, or some fixed number of entries, are given to a purchaser of a sweepstakes qualifying product or to a donor in return for a charitable donation. The purchaser/donor/sweepstakes player may then redeem winning sweepstakes entries for the identified prizes. Sweepstakes prizes may be cash prizes, store credit prizes, or merchandise prizes for example. Commonly, the sweepstakes rules define a top level or “grand” prize, and a number of other prize levels. A sweepstakes game may offer only one or a very small number of grand prizes and larger numbers of prizes at one or more lower prize levels.

The results for the various sweepstakes entries may be determined in several different ways. In some sweepstakes games, each entry is associated with a given sweepstakes result before the entry is distributed to a purchaser/donor/player. In other sweepstakes games, each entry is associated with some identifier and a drawing is held to identify winning entries after the sweepstakes entries are distributed to purchasers/donors/players.

In sweepstakes games associated with the sale of products, the sweepstakes entries may be in the form of tickets (which may be referred to alternatively as playing pieces) that are incorporated in some fashion with the product packaging. For example, a cereal box may have a sweepstakes entry ticket printed on the cereal box itself, and the purchaser/sweepstakes player must cut the entry ticket from the box in order to redeem the entry for any associated prize. In another common example, a sweepstakes entry ticket may be printed on the inside surface of a soft drink lid or on an inside surface of a label secured to the soft drink bottle. In either case, the sweepstakes entry ticket may include a code for identification and/or verification purposes and, where the results are preassociated with the sweepstakes entries, an indicator showing the prize associated with the entry.

Other sweepstakes games do not rely on sweepstakes entry tickets incorporated in product packaging. In these sweepstakes games, separate sweepstakes entry tickets are given to the purchaser/donor/sweepstakes player at the time of the purchase/donation. These sweepstakes entry tickets are preprinted and made available to the retailer or charitable organization for distribution to purchasers/donors/players. As with sweepstakes entry tickets incorporated in product packaging, the tickets distributed separately from products include at least a code for identification and/or verification purposes, and may also include an indicator of the prize associated with the ticket when prizes are preassociated with entry tickets. Where the sweepstakes prizes are indicated in the preprinted entry tickets themselves, the prize indicators are preferably obscured in some fashion so that the ticket distributor cannot see the prize associated with a given ticket before the ticket is distributed. An opaque scratch-off material or an opaque peel-off tab or any other suitable arrangement may be used to obscure the prize indicator.

Some governmental regulations relating to sweepstakes games require that sweepstakes entries must be made available to non-purchasers or non-donors. Thus, the rules for a given sweepstakes game may define an alternate method of entry (AMOE). A common AMOE requires a potential player to submit a postcard or other entry form to some distribution center. The distribution center responds to such a postcard or entry form by returning one or more sweepstakes entry tickets to the postcard/entry form sender.

Regardless of whether sweepstakes entries are incorporated in product packaging, provided in separate preprinted tickets, or distributed in an AMOE procedure, prior sweepstakes systems are limited in the manner in which the sweepstakes prizes may be presented to the player. Typically, a sweepstakes player holding a sweepstakes entry ticket that has been associated with a prize either sees an indicator on the ticket that directly indicates the winning prize or sees a code that can be correlated to a winning prize. Thus, prior sweepstakes systems lack any arrangement for showing sweepstakes results in an attractive and entertaining fashion.

### SUMMARY OF THE INVENTION

The present invention provides a sweepstakes game entry distribution method in which the sweepstakes results may be displayed to the sweepstakes player in an exciting and attractive format at an electronic display terminal. The invention encompasses a method for distributing sweepstakes entries as well as a system and program product for distributing sweepstakes entries and revealing sweepstakes results at an electronic display terminal.

One preferred method embodying the principles of the invention includes associating a product with a user account. The product may be a product such as Internet access time, calling card minutes, gift card credit, other types of store credit, or any other type of product. One or more sweepstakes entries are associated with the user account based at least in part upon the value of the product that has been associated with the user account. The method further includes dispensing a user ticket to a user correlated with the user account. This user ticket is associated with the product through information recorded on the user ticket, and is also printed with a respective indicia for each respective sweepstakes entry associated with the user account.

Distributing sweepstakes entries according to the invention provides a great deal of flexibility in how the results associated with the various sweepstakes entries may be displayed to the product purchaser/sweepstakes player (referred to further herein as the “user”). In particular, methods according to the invention allow the sweepstakes results to be displayed to the user in an attractive and exciting graphic format. One preferred form of the invention includes producing a graphic sweepstakes entry result presentation at a display device in response to a sweepstakes entry reveal command entered at a display terminal with which the display device is associated. This graphic sweepstakes entry result presentation may depict a result in a playing card game, a reel-type game, or any other type of game. Depending upon the nature of the product associated with the user account, this display terminal may also be used to provide the product to the user. For example, where the product is Internet access time, the display terminal may not only be used to show the user their sweepstakes results, but also provide the purchased Internet access.

Some forms of the present invention may include printing the indicia on the user ticket in response to a product purchase request. In addition, associating the user account with one or more sweepstakes entries may be performed in response to the product purchase request. The information through which the user ticket is associated with the product may also be recorded on the user ticket in response to the product purchase request. Associating the user account with each respective sweepstakes entry may include randomly assigning a respective sweepstakes entry record to the user account from a set of sweepstakes entry records.

A preferred system embodying the principles of the invention includes a device for storing a data structure that represents the user account. This data storage device may be associated with a sweepstakes controller that is responsible for assigning sweepstakes entry records to the user account and managing the user account. This preferred system also includes a ticket dispenser for dispensing a user ticket that is printed with indicia for each respective sweepstakes entry associated with the user account. This ticket dispenser may include a printer for printing the indicia on the user ticket, preferably immediately before the user ticket is dispensed to the user. One or more display terminals may be included in the system for revealing sweepstakes results to the system users.

The present invention also includes a program product stored on at least one storage medium. The program product includes a set of machine-readable instructions that are configured to carry out the methods described herein.

These and other advantages and features of the invention will be apparent from the following description of the preferred embodiments, considered along with the accompanying drawings.

### BRIEF DESCRIPTION OF THE DRAWINGS

FIG. 1 is a diagrammatic representation of a sweepstakes system embodying the principles of the invention.

FIG. 2 is a diagrammatic representation of the point-of-sale terminal included in the sweepstakes system shown in FIG. 1.

FIG. 3 is a diagrammatic representation of an access point device, display terminal, and/or combination device included in the sweepstakes system shown in FIG. 1.

FIG. 4 is a diagrammatic representation of a central system that may be used in the sweepstakes system shown in FIG. 1.

FIG. 5A is a diagrammatic representation of one side of a user ticket according to one embodiment of the invention.

FIG. 5B is a diagrammatic representation of the opposite side of the user ticket shown in FIG. 5A.

FIG. 6 is a flow chart showing process steps associated with the operation of the point-of-sale terminals in one preferred form of the present invention.

FIG. 7 is a flow chart showing process steps associated with the operation of a combination device according to one preferred form of the present invention.

FIG. 8 is a flow chart showing process steps associated with the operation of the central system according to an embodiment of the invention.

### DESCRIPTION OF PREFERRED EMBODIMENTS

The invention will be described below in connection with a specific embodiment in which the product being purchased comprises Internet access time. It will be appreciated, however, that the invention is not limited to use in connection with the sale of any particular type of product or service and is certainly not limited to cases in which the product comprises Internet access time. Various alternative systems adapted for use in connection with the purchase of other types of products and services will be described further below.

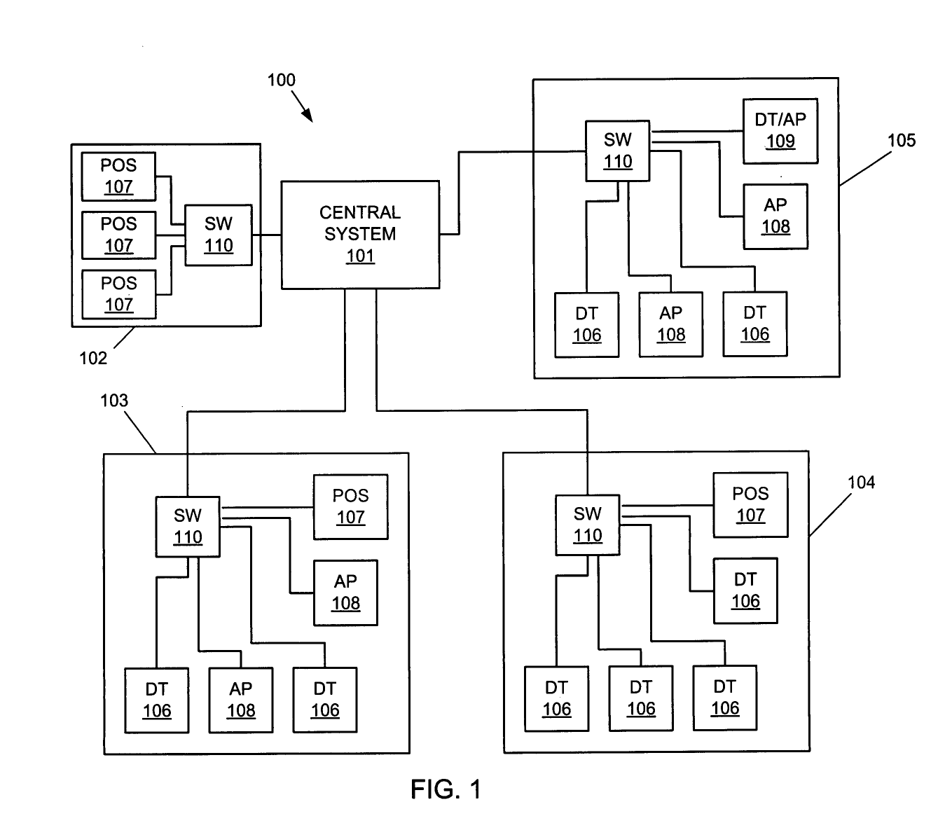

Referring to FIG. 1, a sweepstakes system 100 embodying principles of the invention includes a central system 101 for managing user accounts relating to the sale of Internet access time. Central system 101 communicates with various system devices such as display terminals 106, point-of-sale terminals (POSs) 107, access point devices 108, and combination display terminal/access point devices 109. Each display terminal 106 is referenced with the abbreviation “DT” in the drawings, while the abbreviations “AP” and “DT/AP” are used in the drawings for access points 108 and combined display terminals/access point devices, respectively. Also, combination display terminal/access point devices 109 may be referred to as simply “combination devices” in this disclosure.

Sweepstakes system 100 includes device groups 102, 103, 104, and 105. These device groups will typically, but not necessarily, be located at different physical locations which may be widely spaced apart across a geographic area. Group 102 includes only POSs 107, whereas group 105 includes display terminals 106, access point devices 108, and combination devices 109, but no POS 107. Group 103 includes a POS 107 together with display terminals 106, and access point devices 108, while group 104 includes only a POS 107 and display terminals 106. The particular embodiment of the invention shown in FIG. 1 employs a communications arrangement utilizing switches to help facilitate communications between the various system components. Thus, each device group 102, 103, 104, and 105 includes a switch (SW) 110. It will be appreciated that the network topology shown in FIG. 1 is just one example of an appropriate network communications arrangement. The invention is not limited to any particular network topology or any particular communication technique or protocol. Also, although physical connections are indicated in FIG. 1, communications between system components may be wired or wireless within the scope of the invention. Furthermore, the invention is not limited to any particular numbers of devices included in the various device groups. The specific numbers of POSs 107, display terminals 106, access point devices 108, and combination devices 109 shown in Figure one are shown only for purposes of example.

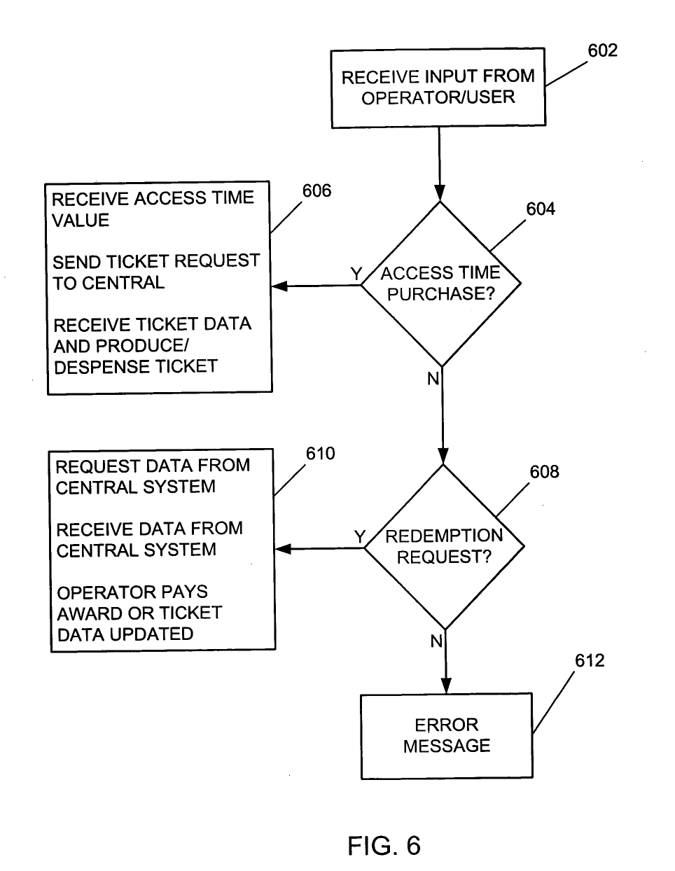

As will be described in detail below with reference to the flow charts of FIG. 6 through 8, system 100 enables a user to purchase Internet access time at a POS 107. System 100 associates the purchased product, that is, the purchased Internet access time, with a user ticket through information such as an account identifier recorded in some fashion recorded on the user ticket. System 100 also associates the user account with one or more sweepstakes entries. The number of such sweepstakes entries is based at least in part on the value of the product that the user has purchased at the respective POS 107. The POS 107 at which the user purchased the product also preferably dispenses the user ticket to the user. The user ticket is also printed with a respective indicia for each respective sweepstakes entry that was associated with the user account in view of the product that was purchased by the user. Each indicia is correlated to a result in the sweepstakes game preferably so that the user may determine the result of a respective sweepstakes game entry merely by viewing the indicia and comparing it to a sweepstakes result table correlating the various types of indicia with a respective sweepstakes game result. Alternatively, the user may go to a display terminal 106 or combination device 109 and use the user ticket, or information associated with the user ticket, to reveal the sweepstakes game results for sweepstakes entries that have been associated with the user's respective user account. As yet another alternative, system 100 may also be configured to allow a user to reveal the sweepstakes entry results at a POS 107. Additionally, or in lieu of one or more of these result revealing arrangements, some forms of the invention may implement a web site through which users may reveal their sweepstakes results using any Internet enabled computer or Internet appliance. Used in this fashion such an Internet enabled computer or Internet appliance may be considered a display terminal within the scope of the present invention.

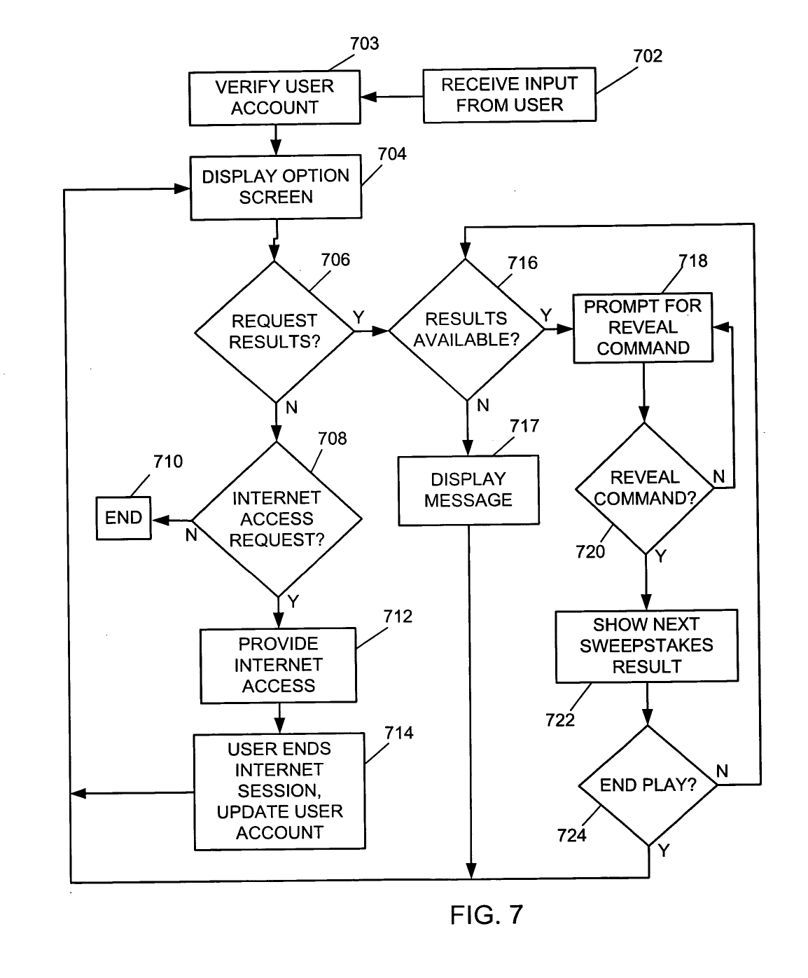

The specific structure of a sweepstakes distribution system embodying the principles of the present invention will depend in large measure on the nature of the product or products that may be purchased. Since the product being purchased in system 100 is Internet access time, the system includes access point devices 108 through which the user may gain Internet access according to their purchase of Internet access time. As will be described further below, the access point devices 108 may comprise computers through which a user may obtain Internet access. Alternatively, the access point devices 108 may comprise or include a wireless gateway device through which a user may gain Internet access using their own wireless enabled portable computer or Internet appliance. Each combination device 109 may comprise a computer system that may serve either to provide Internet access or to display sweepstakes results as will be described below with particular reference to FIG. 3 and the flow chart of FIG. 7.

In the example system 100 shown in FIG. 1 in which the product to be purchased is Internet access time, each device group including access point devices 108 may comprise an Internet cafe. Typically, the Internet cafe will include a POS 107 where Internet access time may be purchased. Groups 103 and 104 are examples of a typical Internet cafe arrangement according to the invention where a user may both purchase Internet access time and obtain Internet access as well as see their sweepstakes results with a display terminal 106 or combination device 109.

However, it is not necessary within the scope of the invention to provide a POS 107 at the same location where the purchased Internet access time may be used. Group 105 in FIG. 1 is an example of a location providing display terminals 107, access point devices 108, and combination devices 109, without providing any POS. On the other hand, it is not necessary according to the invention to provide display terminals 106, access point devices 108, or combination devices 109 at a location where Internet access time may be purchased. Group 102 shows an example of a location in system 100 at which Internet access time may be purchased, but not necessarily used. Of course, the invention is not limited to any particular number of device groups such as groups 102, 103, 104, and 105.

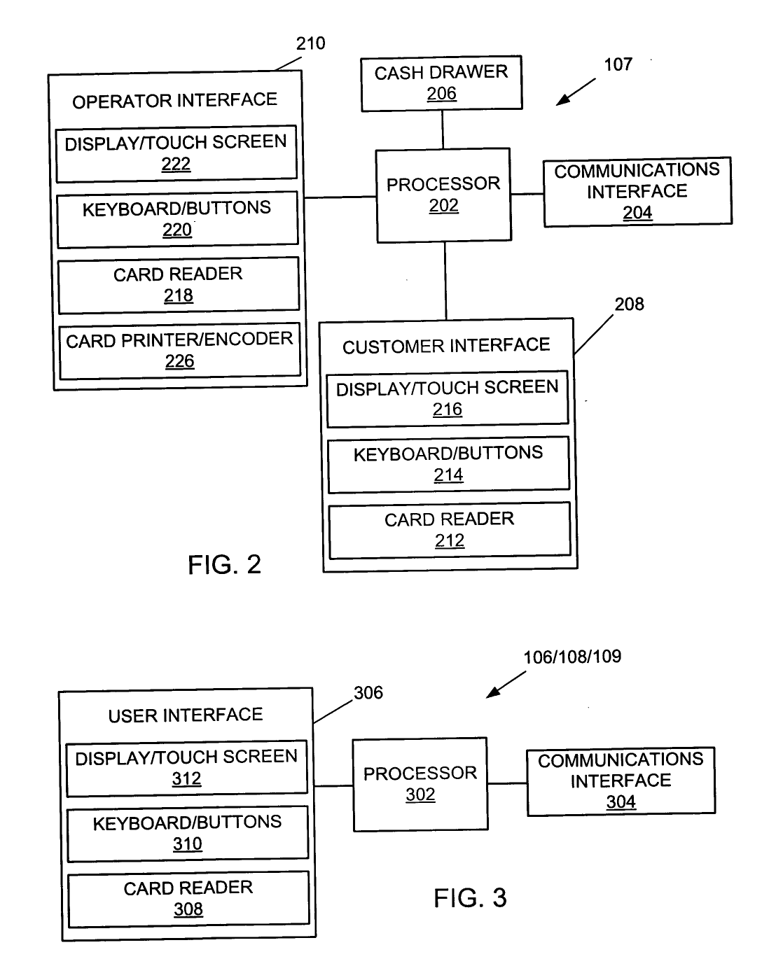

FIG. 2 provides a diagrammatic representation of an example POS 107 that may be used in gaming system 100 shown in FIG. 1. The illustrated POS 107 includes a processor 202 that communicates with central system 101 through a communication interface 204 such as a suitable network interface card and network router. The processor 202 controls a cash drawer 206 and also communicates with a customer interface 208 and an operator interface 210.

The customer interface 208 includes a card reader 212 for reading information from a user's account card. The account card is a physical card such as a credit card, a gift card, or any other type of card that can be correlated to a user account. In one preferred embodiment, the account card may also be printed with the sweepstakes indicia and thus represent a user ticket. However, the user ticket may be separate from a user account card. In one preferred form of the invention, card reader 212 comprises a mag stripe reader and the account cards and user tickets used in the system encode information on a stripe of magnetic material formed on the respective card or ticket. However, the invention is not limited to any particular technology for encoding the required information on a user account card or user ticket. For example, card reader 212 may comprise an optical scanner adapted to read bar codes, recognize graphic characters, and/or read any other optical arrangement in which information may be encoded. As another example, card reader 212 may comprise a smart card reader for reading information from a user account card carrying a suitable data storage device. Also, it will be appreciated that card reader 212 may comprise a combination device adapted to read multiple different types of media or may comprise multiple devices for reading different types of media. In particular, a customer interface within the scope of the invention may include one card reader for reading a user account card dedicated for the user account set up in the sweepstakes distribution system, and another card reader for reading another type of account card, such as a credit card used for purchasing the desired Internet access time, or a single card reader device adapted to read both types of cards.

The keyboard and/or arrangement of mechanical buttons 214 is included in customer interface 208 to allow the user to make various inputs at the respective POS 107. For example, a user may be required to enter an account identifier and/or a personal identification number (PIN) as part of a transaction at the POS 107. Keyboard/buttons 214 may also enable a user to enter certain requests or commands at POS 107. For example, a user may be required to enter a value of Internet access time to be purchased and enter a purchase request and/or verify the purchase request. As another example, a user may be allowed to enter a sweepstakes entry redemption request through keyboard/button arrangement 214.

Part or all of the functionality implemented through keyboard/button arrangement 214 may also, or alternatively, be implemented in a display/touch screen 216. Display/touch screen 216 may also be used to display sweepstake entry results to a user, and/or display other information or graphics to the user. Alternative forms of the invention may include only a display device as part of the customer interface and not a display/touchscreen. It is also possible that a customer interface associated with a POS 107 within the scope of the invention might not include a display.

As with customer interface 208, the illustrated operator interface 210 includes a card reader 218, keyboard/button arrangement 220, and a display/touch screen 222. Card reader 218 may comprise any of the types of card reading devices described above with reference to card reader 212. Generally, card reader 218 may be used to read information from a user account card, a user ticket, or both. Keyboard/button arrangement 220 and display/touch screen 222 allow an operator to enter information and commands. Display/touch screen 222 also allows various notices or other information to be displayed to the POS operator. However, some forms of the invention may include only a display with the operator interface rather than a display/touch screen, and rely on operator inputs through keyboard/button arrangement 220 and card reader 218. Operator interface 210 also includes a card printer/encoder 226 which may be used to print and/or encode user account card and/or user tickets according to the present invention. It will be appreciated that one device may be included at a POS 107 to print a user ticket and a separate device may be included to encode information on the user ticket.

Although the example POS 107 shown in FIG. 2 includes a dual interface arrangement, that is, a separate customer interface 208 and operator interface 210, it will be appreciated that other forms of the invention may not include dual interfaces at the POS 107. In some sweepstakes systems according to the invention, POSs may be unattended devices or kiosks that include only a customer interface. In these types of POSs, a card printer/encoder similar to device 226 shown in FIG. 2 will be included as part of the customer interface or as another component of the POS. Still other sweepstakes systems according to the present invention may use operator or cashier attended POSs that include only an operator interface similar to interface 210, and no customer interface. In these types of systems, the customer provides information to the POS operator/cashier who then enters the information into the system through the operator interface. A user may also be required to hand their account card and/or user ticket to the POS operator/cashier so that the card/ticket may be scanned with a suitable card reader/scanner associated with the POS. Yet other POS arrangements within the scope of the invention may employ a shared operator interface and customer interface, in which both the operator/cashier and customer have access to various components such as a card reader, keyboard/button arrangement, and display/touch screen device. In some forms of the invention, the functions provided by the POS 107 may be provided through a personal computer having Internet access. That is, a website may be implemented to allow a user to purchase the product, in this case Internet access time, through an Internet enabled computer or Internet appliance. In this case, a printer associated with the computer or Internet appliance may be used to print the user ticket as will be described further below. At a minimum, a POS in a system according to the present invention should allow a user to purchase a product and receive a user ticket associated with sweepstakes entries. Some forms of the invention may include no printer and instead rely on user tickets that are preprinted with an appropriate number of indicia each related to a sweepstakes entry.

FIG. 3 provides a diagrammatic representation of a system that may comprise either an access point 108, display terminal 107, or combination device 109 within the scope of the present invention. Each of these system devices may generally include a processor 302 connected for communications to the remainder of the sweepstakes system through a suitable communications interface 304 which may be similar to interface 204 shown in FIG. 2. Each system device (106, 108, and 109) also includes a user interface 306. The illustrated user interface 306 includes a card reader 308, keyboard/button arrangement 310, and display/touch screen 312. Card reader 308 comprises a suitable device for reading a user account card and/or a user ticket. The reader may comprise any of the card reading arrangements described above with reference to card reader 212 shown in FIG. 2. Keyboard/button arrangement 310 may comprise any arrangement of physical buttons, controls, or keys to allow a user to input the desired commands to use the particular device 106, 108, or 109. For example, where the device comprises an access point device 108 or a combination device 109, keyboard/button arrangement may comprise a computer keyboard and a pointing device such as a mouse or trackball. Where the device comprises a display terminal, keyboard/button arrangement 310 may, for example, include a play button that allows a user to make an input to initiate an entry reveal command as will be discussed below. The keyboard/button arrangement 310 for a display terminal may also include controls for enabling the user to select a display type by which sweepstakes entry results are to be revealed, and controls for enabling the user to dictate whether sweepstakes results are to be revealed individually or in some combined fashion. Although access point device 108 may include a display/touch screen 312 as shown in FIG. 3, an access point device may include simply a computer monitor with no touch screen capability. However, a display device associated with a display terminal 106 or a combination device 109 may include a display with touch screen capability for enabling the user to make inputs in the course of a sweepstakes entry result presentation or to initiate the result presentation.

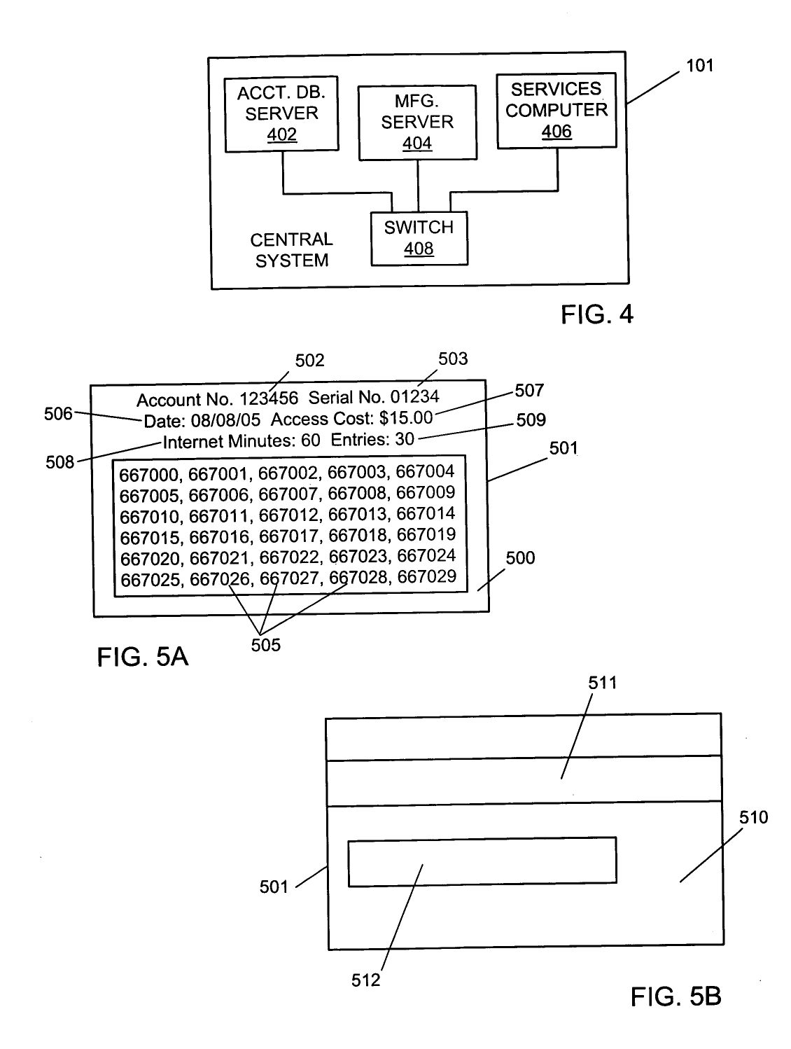

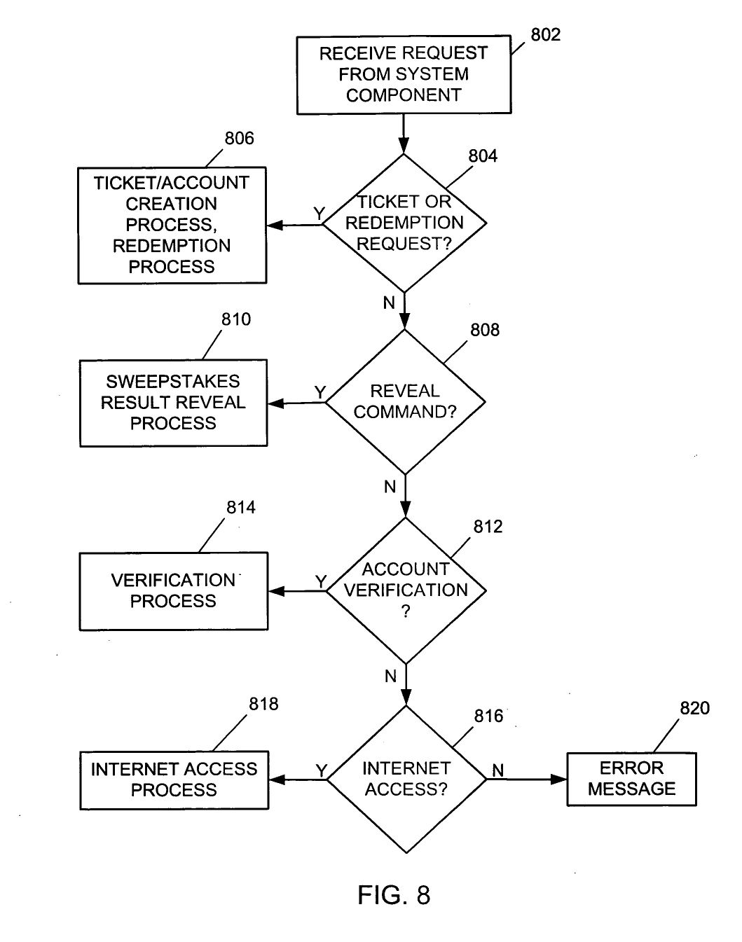

As shown in FIG. 4, central system 101 of the sweepstakes distribution system 100 shown in FIG. 1 preferably includes a number of separate processing devices and their associated components. The central system 101 shown in FIG. 4 includes an account database server 402, a manufacturing server 404, and a services computer 406. Database server 402 maintains databases and data structures preferably used in sweepstakes system 100, including particularly the data structures representing user accounts and related data structures. Manufacturing server 404 manufactures sweepstakes games and may store sweepstakes game sets. These sweepstakes game sets are preferably comprised of a number of predetermined sweepstakes entry records. Each such record is associated with a result in the sweepstakes game and is also preferably associated with some sweepstakes entry record identifier by which the various entry records may be distinguished. In some preferred forms of the invention each sweepstakes entry record comprises a data structure including at least a result field for containing a result index value and a field for the record identifier. Other fields may include a prize value field, a sequence indicator field for storing an indicator of the sequence of the respective record with respect to other sweepstakes entry records in the sweepstakes game. Services computer 406 handles communications to and from POSs 107, display terminals 106, access point devices 108, and combination devices 109. In particular, services computer 406 receives product purchase information from a respective POS 107 associates the appropriate number of sweepstakes entries with the appropriate user account maintained at database server 402, and communicates sweepstakes entry records back to the respective POS 107. Services computer 406 also preferably holds sweepstakes record sets from the manufacturing server 404 and is responsible for acting as the sweepstakes controller to assign sweepstakes entries to the respective user accounts used in the sweepstakes entry distribution system 100 shown in FIG. 1. However, the database server 402 may alternatively store sweepstakes record sets and services computer 406 may obtain sweepstakes entry records from the database server or cause the database server to communicate sweepstakes entry records directly to the appropriate system component as will be described further below with reference to FIG. 8. In any event, since the central system 101 in FIG. 4 includes multiple processing systems that must communicate with each other and may be required to communication with other system components such as POSs 107, display terminals 106, access point devices 108, and combination devices 109 shown in FIG. 1, a suitable communications arrangement is included in central system to facilitate the required communications. FIG. 4 shows a switch 408 for facilitating network communications between the central system components and between the central system components and other components included in sweepstakes entry distribution system 100.

It will be appreciated that the example systems shown in FIG. 1 through 4 are shown only for purposes of example and convenience in describing the present invention. Numerous variations on these systems may be included within the scope of the present invention. For example, the systems in FIGS. 2 through 4 are based on a general purpose computer model, in which processes are performed or controlled by a respective general purpose computer executing operational program code. Other forms of the invention may include special purpose processors for performing and controlling the various functions of the sweepstakes distribution system shown in FIG. 1. Also, although a single general purpose processor is shown for the POS 107 in FIG. 2 and system device 106/108/109 shown in FIG. 3, multiple general purpose processors may be used in some implementations. Similarly, although FIG. 4 shows three separate computing systems 402, 404, 406, the various functions provided by central system 101 may be distributed across more or fewer computer systems within the scope of the invention. It should also be noted that although display terminals 106 are described above as video-style devices in which sweepstakes entry results are presented to the user via a video presentation, some or all of the display terminals included in system 100 may use a non-video type presentation to reveal sweepstakes results to the user. In particular, a mechanical reel slot machine may be used as a display terminal 106 to reveal sweepstakes results to a user.

Those skilled in the are of data processing systems will appreciate that FIGS. 2 through 4 represent highly simplified representations and omit many data processing system details. Such system details include power supplies, non-volatile storage devices, volatile memory, cooling fans, touch screen controllers, and graphics processors for example. With respect to central system 101 in FIG. 4, an operator interface is also omitted from the figure. These system details are omitted from the drawings so as not to obscure the invention in unnecessary detail. The absence of these system details in the drawings is not to be construed as indicating that these common computer system components would not or could not be included in a given implementation of a sweepstakes distribution system according to the invention.

FIG. 5A is a diagrammatic representation of a first side 500 of a user ticket 501 that may be used in a sweepstakes distribution system according to the present invention. Ticket 501 may bear a user account identifier 502, a game serial number 503 identifying the respective sweepstakes game from which entries are taken, and a number of indicia 505 each being associated with a respective sweepstakes entry. First side 500 of user ticket 501 is also printed with a date 506 indicating the date the user ticket was issued, a cost of purchase value 507, a total access time value 508, and a value 509 indicating the number of sweepstakes entries associated with the user ticket. This particular user ticket 502 is similar to that disclosed in U.S. Pat. No. 6,899,622 B2, entitled ELECTRONIC PULL TAB GAMING SYSTEM. U.S. Pat. No. 6,899,622 B2 is incorporated herein in its entirety by this reference. Because the indicia 505 associated with sweepstakes entries are readily visible on user ticket 502 and may be correlated to respective sweepstakes prizes through a suitable prize table, some forms of the invention may include a cover material (not shown) which obscures the indicia 505 at the time the user ticket is dispensed. In this case the user will be required to remove the cover material in order to view the indicia 505.

In the user ticket embodiment shown in FIG. 5A, each sweepstakes entry indicia 505 comprises a verification code that is uniquely identified with a respective result and sweepstakes entry in the sweepstakes game. In other forms of the invention, the indicia printed on the user ticket 502 may comprise generic result identifiers made up of one or more symbols. Preferably, each such generic result identifier would also be labeled on the user ticket as being associated with a particular entry for the user ticket, such as “entry 1,” “entry 2,” and so forth.

FIG. 5B illustrates the opposite side 510 of the game ticket 501 shown in FIG. 5A. The opposite side 510 includes a strip of magnetic media 511 that may be encoded with various data according to the invention. As used here and in connection with alternate forms of user tickets described below, “encoded” means that the data is encoded in some machine readable form and is not necessarily readable to a person without the aid of a machine. A signature space 512 is also included on side 510 of user ticket 501.

A user ticket that may be used in the present sweepstakes distribution system may include numerous variations from the example user ticket 501 shown in FIGS. 5A and 5B. Of course, rather than a magnetic strip 511, the ticket 501 could include a bar code or other type of optically read code (not shown). Other forms of a user ticket may include memory a circuit for storing the data that may be stored on magnetic strip 511 in the example user ticket 501. Also, a user ticket within the scope of the invention need not have the particular configuration of example ticket 501. Alternate user tickets may include a magnetic strip or other data carrying arrangement on the same side of the ticket as the sweepstakes entry record indicia and card identifying information. User tickets also need not be rectangular. The substrate from which a user ticket is formed may be paper, plastic, or any other suitable material for a given combination of features to be included on the user ticket. One particular type of user ticket within the scope of the invention comprises a ticket printed in the same fashion as a receipt may be printed at a POS 107 (FIG. 1). In these types of user tickets, the user account identifier is preferably optically encoded on the ticket with a bar code or other suitable code, and information on the user account, including information on sweepstakes entries and results associated with the user account, is stored at a suitable component (such as central system 101) and is accessible via the user account identifier that may be read from the user ticket.

Regardless of whether the data is encoded on a magnetic strip such as strip 506 in FIG. 5B, or encoded in a bar code, memory circuit, or any other device or arrangement on the ticket, the user ticket is associated with the purchased product through information recorded on the user ticket. That is, information recorded on the user ticket associates the user ticket with the product which was purchased to entitle the user to the sweepstakes entries. This information may be recorded on the ticket in a number of different fashions. In one arrangement, the user ticket is encoded with the user account identifier coinciding with the account identifier (such as account identifier 502) that may also be printed or otherwise formed on the ticket. A product identifier such as access time value 508 in FIG. 5A, a purchase price such as price 507 in FIG. 5A, or any other information may be printed and/or encoded on the user ticket to associate the user ticket with the purchased product. The user ticket may also be encoded with the sweepstakes game serial number such as serial number 503 shown in FIG. 5A.

In some implementations of the invention, a user ticket such as ticket 501 may be encoded only an account identifier. This account identifier may be used to access all of the necessary data associated with the user ticket stored in suitable data structures maintained by the sweepstakes system. In other implementations of the invention, the user ticket 501 may be encoded with information regarding the sweepstakes entries that have been assigned to the user account, or may be encoded with the sweepstakes entry records themselves. As will be discussed further below, even where the actual sweepstakes entry data is encoded on the user ticket, a suitable system component such as central system 101 stores the sweepstakes entry data at least for verification purposes. These and other variations in a user ticket that may be used in the present invention will be apparent in the following discussion of the operation of the invention in view of the flow charts presented in FIGS. 6 through 8.

The flow chart of FIG. 6 shows process steps associated with the operation of the POSs 107 in the example sweepstakes distribution system 100 shown in FIG. 1. As shown at process block 602, the process performed at a respective POS 107 includes receiving an input from an operator or user of the respective POS. If this input comprises a product purchase request, that is, a request to purchase Internet access time as indicated at decision block 604, POS 107 goes through the steps indicated at block 606 in order to complete the purchase of Internet access time and produce the user ticket for the sweepstakes game entries that have been assigned to the purchaser. If the input received at process block 602 does not represent a request to purchase Internet access time but instead represents a request to redeem a sweepstakes entry as indicated at decision block 608, POS 107 then goes through the sweepstakes entry redemption process indicated at process block 610 in FIG. 6. In the example process shown in FIG. 6, the only two possible inputs at block 602 are requests to purchase Internet access time and requests to redeem a result associated with a sweepstakes entry. Thus, if the input at block 602 is not recognized as either of these types of requests, then POS 107 produces an error message for the operator and/or user as indicated at block 612.

The input received at POS 107 as indicated at process block 602 in FIG. 6 may be entered in any number of ways within the scope of the invention. Where POS 107 includes a customer interface such as that shown at 208 in FIG. 2, the customer may make the desired input themselves through that interface. Where POS 107 includes only an operator interface such as that shown at 210 in FIG. 2, or where both operator and customer interfaces are included, a customer may ask the POS operator to make a suitable input through the operator interface. In any case, the input may require entering at least some information required to complete the request. For example, a suitable input at block 602 may be required to include or to identify the user account for the respective customer and perhaps enter a PIN. Alternatively, user account information and any required PIN may be entered later in the process as part of the steps at block 606 or 610 in FIG. 6.

The specific process steps required for completing a purchase of Internet access time at process block 606 may also vary greatly from one implementation of the invention to another. Generally, completing an Internet access time purchase request includes receiving the amount of product to be purchased, that is, the amount of Internet access time to be purchased. This information may be entered at the POS 107 by the customer or the POS operator depending upon the configuration of the respective POS. The POS 107 may also cause a user ticket request to be communicated to the component responsible for assigning sweepstakes game entries, such as central system 101 in FIGS. 1 and 4 for example. A request for Internet access time will also be communicated to the system component responsible for assigning Internet access time for a customer. In one form of the invention, central system 101 may also be responsible for managing Internet access time and thus, the communication for requesting Internet access time may be combined with the communication for requesting sweepstakes entries. Also, in some forms of the invention, the communication requesting Internet access time may itself represent a request for sweepstakes entries. Once the sweepstakes entry request and Internet access time request are communicated to the appropriate system component or components, POS 107 waits for a return communication that includes sufficient information for POS 107 to cause a user ticket to be dispensed. This information may include data regarding each sweepstakes entry assigned for the purchase of Internet access time, the user account identifier that has been associated with the purchased Internet access time, a serial number to be assigned to the user ticket, and perhaps other information. Ultimately, the POS 107 caused the appropriate user ticket to be dispensed for the customer. This process may include selecting an appropriate user ticket from stores of preprinted or partially preprinted user tickets at the POS 107, or may include printing information on a blank user ticket substrate. In either case, the POS 107 preferably encodes the user account identifier and perhaps other information on the user ticket in machine readable form using a suitable encoding arrangement for the respective type of user ticket being used in the system. POS 107 may also issue a receipt for the purchase of Internet access time in the system.

The processes performed at block 610 in FIG. 6 will depend at least in part upon the manner in which sweepstakes entries are associated with a user account in the given implementation of the system. Where only a user account identifier is encoded on the user ticket, and not direct information on the assigned sweepstakes entries, the processes at block 610 preferably includes causing a communication to be sent to the appropriate system component to obtain sweepstakes entry information. For example, central system 101 shown in FIG. 4 may store assigned sweepstakes entries so as to be accessible by the user account identifier. In this example, POS 107 causes a communication to be sent to central system 101 by which the central system may recall information on at least the next sweepstakes entry result to be redeemed for the given user account, and perhaps all of the sweepstakes entry results associated with the user account. POS 107 would then receive the requested information from central system 101 as indicated at block 610 in FIG. 6. POS 107 would then pay to the user any prize associated with each redeemed sweepstakes entry result. This payment may be in cash for cash prizes, or may be in the form of cash credit or Internet access credit. Where sweepstakes prizes are physical items, the payment may involve dispensing the physical item at the POS or dispensing a voucher at the POS which may be redeemed at some other location such as a sweepstakes headquarters location or at a prize redemption station (not shown in the figures). Depending upon the configuration of the POS 107, the award may involve operator action or may be completely automated.

In alternate forms of the invention, the user ticket (such as ticket 501 in FIGS. 5A and 5B) may be encoded with information identifying the respective sweepstakes entry or entries associated with the user account. In this case, no communication is required to another system component in order to redeem a sweepstakes entry result for any associated sweepstakes prize. That is, the sweepstakes result information may simply be read from the user ticket in a suitable fashion and then POS 107 or the POS operator may award the indicated prize or prizes to the user. However, even where sweepstakes entry result information is encoded on the user ticket, the information is preferably verified by communication with a component such as central system 101 in FIGS. 1 and 4. Also, information regarding the redemption activity is also preferably communicated from POS 107 to the appropriate system component to allow that system component to update its records/data structures regarding the user account. Of course, POS 107 would also update the information encoded on the user ticket to indicate which sweepstakes entries have been redeemed.

A redemption request entered at process block 602 in FIG. 6 may be made after a user has seen one or more sweepstakes entry results for a given user ticket issued according to the invention. As will be described further below in connection with FIG. 7, the result associated with a sweepstakes entry may be revealed using a display terminal (106 in FIG. 1) or a combination device (109 in FIG. 1), and then the user may actually redeem the results at a POS 107. However, some forms of the invention may give the user the option to redeem sweepstakes entries for the associated result directly at a POS 107 without having to first reveal the results through an entry result presentation at another system device or a the POS. Other forms of the invention may allow a user to reveal sweepstakes entry results at a suitable device such as a display terminal 106 or combination device 109 in FIG. 1, and also redeem the results directly at the respective display terminal or combination device. The display terminals 106 and combination devices 109 in this latter form of the invention will be equipped with s suitable prize dispenser for dispensing prizes or a voucher printer for printing vouchers which may be traded in for sweepstakes prizes at a POS 107 or at some other location.

FIG. 7 shows process steps associated with the operation of a combination device such as device 109 shown in FIG. 1. As indicated at process block 702 in FIG. 7, combination device 109 receives an input initiated by a user to initiate the process. This user input may include reading the user ticket with a suitable reader at the combination device 109, such as the reader 308 in FIG. 3 or receiving the account identifier manually input through a suitable input device such as keyboard arrangement 310 shown in FIG. 3. The user account is preferably verified as indicated at process block 703, preferably by communication with central system 101. If the user account is valid, a user option screen is displayed to the user as indicated at process block 704. This user option screen enables the user to choose the function to be performed at the combination device 109. That is, the user option screen allows the user to make an input to select operation as a display terminal to display sweepstakes entry results or operation as an access point to use the purchased Internet access time. The user option screen in the process illustrated in FIG. 7 also preferably provides a “log off” option.

If the user selects to use the combination device 109 as an Internet access device as indicated by a negative result at decision block 706 and a positive result at decision block 708, Internet access is provided as shown at process block 712. This step shown at block 712 may include configuring the combination device to provide the desired access. For example, combination device 109 may load a suitable Internet browser program and an email program in response to a user's selection to use the combination device as an Internet access device. The step of providing Internet access as shown at process block 712 may also include sending communications to the system component responsible for managing the user accounts and also receiving communications from that component. For example, combination device 109 will at least communicate to the system component responsible for managing user accounts such as central system 101 to allow that component to know when the user's Internet session starts. Also, preparatory to providing Internet access, combination device 109 may communicate with central system 101 to determine how much Internet access time the user has remaining associated with their user account. Alternatively, this verification may have been performed at block 703 as part of the user log on procedure.

Regardless of how the desired Internet access is provided at combination device 109, the user will eventually end the Internet session either by entering a suitable end session command or by using up all of their Internet access time. At that point, combination device 109 may send a communication to central system 101 indicating that the user has ended their Internet session so that the central system may update the user account accordingly. The process at combination device 109 may then return to displaying the user option screen as indicated a process block 704 in FIG. 7 so that the user may select to see their sweepstakes results or perhaps reinitiate their Internet access session if they have access time remaining in the Internet access account.

It will be noted that a communication from combination device 109 may not be required to signal to central system 101 that the access session has ended if the user has exhausted their Internet access time and the central system itself has caused the Internet session to terminate. It will also be noticed from FIG. 7 that if the user has not selected Internet access as indicated at decision block 708, the only other option is that the user has logged off the device, and thus the process then ends as indicated at process block 710.

If the user has requested to see any sweepstakes results for sweepstakes entries that have been associated with their user account as indicated by a positive result at decision block 706, the process shown in FIG. 7 then determines if sweepstakes results are available as indicated by decision block 716. In some preferred forms of the present invention, the determination at decision block 716 is whether the user's account is associated with any sweepstakes entries for which results have not previously been revealed to the user. In other forms of the invention, the determination at block 716 is whether the user's account has any unredeemed sweepstakes results. In either case, the determination may include communications with the user account management component such as central system 101 in FIG. 1. These communications may include a query from combination device 109 and a response to the query. Alternatively, this information from the user account management component may have been communicated to combination device 109 as part of the verification process shown at block 703. In this case, the determination indicated at block 716 may involve merely analyzing the account information that was communicated to combination device 109 as part of account verification at process block 703.

If the result of the determination at block 716 is that no sweepstakes results are available to be revealed to the user, a suitable message indicating that result is displayed to the user as shown at process block 717 and the process returns to displaying the user option screen as shown at process block 704. If sweepstakes results are available to be revealed to the user as indicated by the determination made at decision block 716, the process at combination device 109 may including prompting the user for a sweepstakes entry reveal command (reveal command) as shown at process block 718. Prior to prompting for a reveal command, combination device 109 may also be configured, or configure itself, to serve as a display terminal in the sweepstakes system. This may include changing the graphics displayed at the display device associated with the combination device 109. It may also include giving the user a choice of selecting how the sweepstakes results are to be revealed in a sweepstakes entry result presentation. For example, the user may be enabled to choose between a slot machine style display for showing sweepstakes results, a card game type display, a simulation of some other casino game, a simulated horse or 5 dog race, or some other type of entertaining display. In preferred forms of the invention, the user will be required to initiate a reveal command by some input appropriate for the type of display used to reveal results. For example, where the display is a slot machine style display, the reveal command may be entered when the user activates a physical or virtual “Play” button associated with combination device 109. Where the display is related to a card game the user may be required to activate a “Deal” button to enter a reveal command. Card game type displays and other types of displays may require more that one input by the user in order for the user to see their result. For example, a card game type display may allow a user to draw additional cards, and a horse or dog race type display may allow the user to select their horse or dog from a given field.

When the reveal command is entered as indicated by the result at decision block 720, combination device 109 shows the user the next sweepstakes entry result that may be revealed to the user as indicated at process block 722. This step preferably includes producing the appropriate sweepstakes result presentation. Preferred forms of the invention rely on the underlying sweepstakes entry result to dictate the results ultimately shown by the card game, race, or other sweepstakes entry result presentation. For example, a sweepstakes entry result may pay a cash prize of $5. In this case, the result in the presentation will be controlled at combination device 109 so that the result in the presentation coincides with the $5 sweepstakes entry result. Continuing with this example in a poker type presentation, the user's final card hand would be controlled to show a hand which returns a prize of $5 according to the rules of the poker game. Once the result is revealed through the respective presentation type, the user may be allowed to reveal further sweepstakes results or discontinue revealing results as indicated by decision block 724. When the user indicates their desire to discontinue revealing sweepstakes results, the illustrated process returns to the user option display at process block 704. Otherwise, the process returns to the reveal command prompt shown at process block 718.

It will be appreciated that the step of revealing the next sweepstakes result to the user as indicated at process block 722 may require communications-from combination device 109 to the system component responsible for managing user accounts, such as central system 101 shown in FIG. 1. For example, an implementation of the invention may require that combination device 109 initiate a request for the next sweepstakes entry result in response to a reveal command entered at block 720 in FIG. 7. This request would be communicated to central system 101 which would respond with information on the next available sweepstakes entry result for the user. This information on the next available sweepstakes entry result may include as little as a result index value which specifies a given result in the sweepstakes game. Alternatively, some forms of the invention may communicate all of the available sweepstakes entry results for the user to combination device 109 as part of the account verification process at block 703 or otherwise. In this case, the information required for combination device 109 to display the next sweepstakes entry result to the user is already at the combination device and no communication to central system 101 is necessary.

As mentioned above, the process shown in FIG. 7 is specific to a combination device such as device 109 in FIG. 1, which may be used as an access point device to gain Internet access or as a display terminal to reveal sweepstakes results associated with the Internet access time the user has purchased. Dedicated access point devices such as devices 108 shown in FIG. 1 may perform only those steps shown in FIG. 7 associated with using the purchased Internet access time. That is, a dedicated access point device 108 in FIG. 1 may perform only the steps shown at process blocks 702, 703, 712, and 714 shown in FIG. 7. A dedicated access point device may or may not show a separate user option screen in the process of providing Internet access. Where no user option screen is used, the access point device may simply activate an Internet browser once the user account has been verified with unused Internet access time available for the user account. The user may close or exit the browser to end the Internet access session.

A dedicated display terminal such as display terminal 106 shown in FIG. 1 may also perform only a subset of the processes shown in FIG. 7. For example, a display terminal 106 may receive an input from a user as indicated at process block 702 in FIG. 7, verify the user account as shown at process block 703, and determine if sweepstakes entry results are available to be revealed as indicated by decision block 716. If sweepstakes entry results are not available, the display terminal 106 may display an appropriate message and then log the user off the device.

Otherwise, the dedicated display terminal 106 may perform the steps described above with reference to process blocks 718, 720, 722, and 724 in FIG. 7. When the user discontinues play as indicated at process block 724, the dedicated display terminal 106 may simply log the user off the device, dispense any prize or voucher remaining to be dispensed to the user, and go to an attract display mode.

FIG. 8 may be used to describe preferred process steps associated with the operation of the user account management component such as central system 101 of sweepstakes system 100 shown in FIG. 1. At process block 802, central system 101 receives a request from a system component such as a POS 107, a display terminal 106, an access point 108, or a combination device 109. The process shown in FIG. 8 assumes that there are five different types of requests that may be received at central system 101 from the other system components. A ticket request may be received from a POS 107 or a redemption request may be received from a POS, display terminal 106, or combination device 109 as indicated at decision block 804 in FIG. 8. A communication resulting from sweepstakes entry reveal command may be received from either a display terminal 106 or a combination device 109 as indicated at block 808. An account verification request may be received from any of the system components 106, 107, 108, and 109 shown in FIG. 1 as indicated at 812 in FIG. 8, and a request for Internet access may be received from either an access point device 108 or a combination device 109. If the communication is not recognizable as one of these general types of communications, then some error has apparently occurred and the central system 101 returns an appropriate error message to the device from which the communication was received as indicated at block 820 in FIG. 8.

If the request received at central component 101 comprises a request for a user ticket associated with the purchase of Internet access time at a POS 107, or a prize redemption request from a POS 107, display terminal 106, or combination device 109, the process branches from decision block 804 in FIG. 8 to process block 806. In response to a user ticket request, a ticket/account creation process is performed at central system 101. This process may include creating a user account if a user account is not already created. The user account creation step will generally include assigning an account identifier and may include setting up the data structures that will be used to track the user account. The ticket/account creation process indicated at process block 806 in FIG. 8 may also include assigning one or more sweepstakes entries to the user account. These sweepstakes entries are assigned based at least in part on the value of the product being purchased. In the example user ticket shown in FIG. 5A, one sweepstakes entry is assigned for every two minutes of Internet access time being purchased. In this case, the quantity of sweepstakes entries assigned is based entirely on the value of the product purchased, that is, the product purchase price. Other forms of the invention may assign a sweepstakes entry for each incremental quantity of product over a certain minimum amount, or may assign sweepstakes entries based on purchases only on certain days of the week and/or at certain times of the day, or in any other fashion at least partially based on the value of the product being purchased. In one preferred form of the invention specific sweepstakes entry records from a sweepstakes game are assigned to the user account and data regarding the specific sweepstakes entries is recorded for the user account. Other forms of the invention may assign only the right to a sweepstakes entry at this point in the process and not a specific sweepstakes entry. In this latter form of the invention, specific sweepstakes entries are assigned only in response to a reveal command initiated at a display terminal 106 or combination device 109, and the user account merely keeps track of the number of sweepstakes entries to which the user is entitled and may keep a record of the specific sweepstakes entries assigned to the user account as such entries are assigned. In any case, the ticket/account creation process at central system 101 preferably includes communicating sufficient information to the device from which the request was received so that the respective device may produce or dispense the appropriate user ticket as discussed above in connection with FIG. 6.

In the event the request identified at decision block 804 is a redemption request, the process conducted at block 806 comprises a suitable process for enabling the user to redeem the sweepstakes prizes to which they are entitled by virtue of the sweepstakes entries that have been assigned to the user pursuant to the user's purchase of Internet access time. For example, a redemption process may include identifying the prize or prizes to be awarded to the user based on their sweepstakes entries, communicating information on the prizes to the requesting system device such as one of the POSs 107, and modifying the user account to indicate which of the user's prizes have been redeemed. As discussed above in connection with FIG. 6, sweepstakes entry results may be redeemed at a POS 107 by issuing a voucher that the user may trade in for a physical prize. In this case, the information returned to the POS 107 is sufficient to enable the POS to direct the production of an appropriate voucher. Alternatively, sweepstakes entry results may be redeemed at a POS 107 by the POS or POS operator dispensing the sweepstakes prize or prizes directly to the user. In this latter case, the information returned to the POS 107 from the user account management component is sufficient to display to the POS operator what prize is to be dispensed or is sufficient to cause the POS to dispense the prizes without operator intervention, and preferably produce an appropriate receipt for the dispensed prize.

In some preferred forms of the invention, sweepstakes entry results may be redeemed directly at a display terminal such as a display terminal 106 in FIG. 1 or a combination device 109 in that figure. In one preferred arrangement, each display terminal 106 and combination device 109 may include a dispensing device for dispensing prizes directly to the user. In this case, the information returned to the terminal 106 or device 109 from central system 101 in response to the redemption request is sufficient information to allow the terminal 106 or device 109 to direct the dispensing device to dispense the prizes. In another arrangement, display terminals 106 and combination devices 109 may each include a printing/encoding device that produces a voucher which may be traded for the sweepstakes prize or prizes similarly to the voucher described above produced by a respective POS 107.

If the request received from the system component is a communication resulting from a reveal command initiated at a display terminal such as terminal 106 in FIG. 1 or a combination device such as combination device 109 in FIG. 1, then the process shown in FIG. 8 branches from decision block 808 to process block 810. As indicated at process block 810, central system 101 responds to the request resulting from a reveal command by conducting the appropriate reveal process. This reveal process at central system 101 may include communicating information on the next assigned sweepstakes entry back to the requesting device so that the requesting device may reveal the result to the user. It should be noted, however, that in implementations of the invention in which the assigned sweepstakes entry information has been communicated to the display terminal 106 or combination device 109 already as part of the account verification process indicated at block 703 in FIG. 7, there may be no request received at central system 101 to produce a positive outcome at decision at block 808 and no reveal process 810 at the central system. Rather, the display terminal 106 or combination device 109 at which the reveal command was initiated responds to the sweepstakes result request itself without the need for assistance from central system 101. Even in this case, the display terminal 106 or combination device 109 may send information to central system 101 to allow the central system to appropriately update the data associated with the user account.

In the event that the request received by central system 101 comprises an account verification request, the process branches from decision block 812 in FIG. 8 to the verification process shown at process block 814. In some forms of the invention, the process at block 814 may include returning to the requesting device an indicator that the account is valid or invalid. Alternatively, as discussed above, the communication back to the system device requesting user account verification may include sufficient information on the respective user account to enable the requesting device to identify sweepstakes entry results, to reveal sweepstakes entry results, and to redeem any prizes correlated to those results. It should also be noted that the present invention may be implemented in a manner that does not include any separate account verification request from central system 101. Rather, account verification may be implicit in the communications related to a ticket request, redemption request, sweepstakes entry result reveal request, and Internet access request.

If the request received at central system 101 comprises a request associated with the use of purchased Internet access time, the process shown in FIG. 8 branches from decision block 816 to the Internet access process indicated at process block 818. In some cases the request producing the affirmative result at decision block 816 may comprise a request to start Internet access at an access point device 108 or combination device 109 shown in FIG. 1. In these cases, the process shown at process block 818 may include merely starting a timer to decrement available Internet access time and communicating an Internet access enabling instruction to the device from which the Internet access request originated. In the event the Internet access request received at central system 101 comprises a request to end an Internet session, the Internet access process at process block 818 may include stopping the timer and updating the remaining Internet access time as necessary, and may also include sending a communication to the requesting device to disable Internet access.

As indicated above, some preferred forms of the invention may allow a user to see their sweepstakes entry results through an Internet website. In these forms of the invention, central system 101 may implement an Internet server that is suitable for hosting the website. The website may be implemented such that a user may log in to the website from any Internet enabled computer or Internet appliance and enter either their account identifier or the individual user ticket indicia. The website would then respond with a suitable presentation to reveal the sweepstakes entry results to the user. In preferred forms of the invention the website host would serve as a gateway through which central system 101 would respond to reveal commands entered at the Internet enabled computer or Internet appliance.

Although the above-described example system 100 shown in FIG. 1 is directed to a system in which the product to be purchased comprises Internet access time, it will be appreciated that the invention is by no means limited to any particular product or products. Systems according to the invention may vary widely to accommodate various products that may be associated with sweepstakes games. The product may, for example, be a phone card associated with long distance and/or local telephone access time. In this case, the access point devices may comprise telephones. The telephones may be either particular units associated with the system or may be any telephone available to the public. One preferred arrangement may include no dedicated telephones connected in the system, but rely entirely on public telephones. Such a system would include no access point devices such as those shown at 108 in FIG. 1.

In another form of the invention, the product being purchased comprises a prepaid store gift card or credit card. Where the product comprises such a prepaid store gift card or credit card, the sweepstakes system according to the invention may include no access point devices or combination devices such as devices 108 and 109 in FIG. 1. Rather, the system may include only point-of-sale terminals such as POSs 107 and display terminals such as terminals 106 shown in FIG. 1. The POS terminals in these implementations of the invention may comprise regular store terminals where items including store credit or gift cards may be purchased.

In yet other forms of the invention, the products associated with the sweepstakes game may be tangible products. For example, sweepstakes entries may be associated with a user account according to the invention based on a user's purchase of gasoline or other fuel at a service station, or the purchase of various products at a convenience, or the purchase of various products at a number of stores using a particular credit or debit card. In the case of sweepstakes entries based on the purchase of fuel, the point-of-sale terminal may comprise the attended cashier's terminal at the place of purchase or may comprise an automated dispenser such as a pay-at-the-pump style fuel pump. The user ticket may be printed by the receipt printer of either the automated dispenser or cashier's terminal, or a separate user ticket card dispenser may be included with either device. Such a sweepstakes system where the products entitling the user to sweepstakes entries comprise fuel or other tangible products, again will include no access point devices such as devices 108 in FIG. 1. The display terminals for revealing sweepstakes entry results to the users in these types of sweepstakes systems may be included at the stores where the purchases are made or may be included at separate locations, or both.

It should further be noted that the user accounts used in the present sweepstakes distribution invention may vary greatly from one implementation to the next. In some forms of the invention, the user account with which sweepstakes entries are associated is a separate account from the account associated with the product or service being purchased which entitled the user to the sweepstakes entries. For example, an implementation of the form of the invention shown in the figures may utilize a user account with which to associate sweepstakes entries and a separate product account with which the Internet access time is associated. These two accounts are preferably linked in a suitable fashion, but remain separate accounts with separate account identifiers. However, other implementations of the system shown in the figures may use a single account both as a user account with which to associated sweepstakes entries and with which to associate the purchased Internet access time. These same account variations may be used in sweepstakes distribution systems according to the invention that are associated with other types of products. For example, where the produce is a store credit card or gift card, for example, the user account may be the store credit card or gift card account or a separate account.

Another account type variation within the scope of the invention, relates to systems in which sweepstakes entries are distributed for purchases of fuel or other credit purchases. In these cases, where the purchase which entitled the user to the one or more sweepstakes entries is made on a credit card, the user account with which the sweepstakes entries are associated may be the credit account itself or a separate account linked to the credit account in a suitable fashion. This linking may be by credit account number associated with the purchaser's credit card or by some other unique value associated with the credit card, or with a combination of information from the credit card. The user may gain access to the system to reveal sweepstakes entries either by causing their credit account card to be read at a display terminal such as a terminal 106 in FIG. 1, or by causing their user ticket to be read at the display terminal.

A sweepstakes entry distribution system according to the invention may include an alternative method of entry (AMOE) procedure that allows a person to obtain one or more sweepstakes entries without having to purchase a product. In one preferred arrangement, a person may send appropriate identifying information (name, mailing address, etc.) to a sweepstakes operator. The operator may then cause a user ticket to be printed for the person and may make the user ticket available to the requesting user. For example, the sweepstakes operator may mail the user ticket back to the requesting person or may leave the user ticket at some specified location to be picked up by the requesting user. In the case of the AMOE generated user ticket, the user ticket will not be associated with any product. However, the person acquiring the AMOE generated user ticket may reveal the sweepstakes entry result or results associated with the user ticket in any of the ways described above for revealing results, and may redeem results in any of the ways described above.

It should also be noted that participation in a sweepstakes game according to the invention may be voluntary. That is, a user may be given the option of receiving sweepstakes entries as described above, or foregoing those sweepstakes entries. The procedure at a point of sale device in this case may require additional steps to allow the user to select their participation option.

As used herein, whether in the above description or the following claims, the terms “comprising”, “including”, “carrying”, “having”, “containing”, “involving”, and the like are to be understood to be open-ended, that is, to mean including but not limited to. Only the transitional phrases “consisting of” and “consisting essentially of,” respectively, shall be closed or semi-closed transitional phrases, as set forth, with respect to claims, in the United States Patent Office Manual of Patent Examining Procedures (Eighth Edition, August 2001 as revised May 2004), Section 2111.03.

Any use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The above described preferred embodiments are intended to illustrate the principles of the invention, but not to limit the scope of the invention. Various other embodiments and modifications to these preferred embodiments may be made by those skilled in the art without departing from the scope of the following claims. In particular, the various processing steps described above may be performed by any suitable processing device or devices included in the system.

1. A method including:
(a) associating a product with a user account;
(b) associating the user account with one or more sweepstakes entries, the quantity of sweepstakes entries being based at least in part on a value of the product; and
(c) dispensing a user ticket to a user correlated with the user account, the user ticket being associated with the product through information recorded on the user ticket, the user ticket also being printed with a respective indicia for each respective sweepstakes entry associated with the user account.

2. The method of claim 1 further including printing the indicia on the user ticket in response to a product purchase request.

3. The method of claim 2 wherein associating the user account with one or more sweepstakes entries is performed in response to the product purchase request.

4. The method of claim 1 further including recording on the user ticket the information through which the user ticket is associated with the product, the recording being performed in response to a product purchase request.

5. The method of claim 1 wherein associating the user account with one or more sweepstakes entries includes assigning a respective sweepstakes entry record to the user account for each respective sweepstakes entry in the quantity of sweepstakes entries, each respective sweepstakes entry record being assigned from a set of sweepstakes entry records.

6. The method of claim 1 further including producing a graphic sweepstakes entry result presentation at a display device in response to a sweepstakes entry reveal command entered at a display terminal associated with the display device.

7. The method of claim 6 further including providing the product to the user through the display terminal.

8. The method of claim 7 wherein the product comprises Internet access time.

9. A program product stored on at least one storage medium, the program product including machine-readable instructions that when executed are configured to:
(a) associate a product with a user account;
(b) associate the user account with one or more sweepstakes entries, the quantity of sweepstakes entries being based at least in part on a value of the product; and
(c) cause a user ticket to be dispensed to a user correlated with the user account, the user ticket being associated with the product through information recorded on the user ticket, the user ticket also being printed with a respective indicia for each respective sweepstakes entry associated with the user account.

10. The program product of claim 9 further including machine-readable instructions that when executed are configured to cause the indicia to be printed on the user ticket in response to a product purchase request.

11. The program product of claim 10 wherein the machine-readable instructions are configured to associate the user account with the one or more sweepstakes entries in response to the product purchase request.

12. The program product of claim 9 further including machine-readable instructions that when executed are configured to cause to be recorded on the user ticket the information through which the user ticket is associated with the product, the recording being performed in response to a product purchase request.

13. The program product of claim 9 wherein the machine-readable instructions executable to associate the user account with the one or more sweepstakes entries include machine-readable instructions that when executed are configured to assign a respective sweepstakes entry record to the user account for each respective sweepstakes entry in the quantity of sweepstakes entries, each respective sweepstakes entry record being assigned from a set of sweepstakes entry records.

14. The program product of claim 9 further including machine-readable instructions that when executed are configured to cause a graphic sweepstakes entry result presentation to be produced at a display device in response to a sweepstakes entry reveal command entered at a display terminal associated with the display device.

15. The program product of claim 14 further including machine-readable instructions to provide the product to the user through the display terminal.

16. The program product of claim 15 wherein the product includes Internet access time.

17. A system including:
(a) a device for storing a data structure representing a user account, the user account being associated with a product and with one or more sweepstakes entries, the quantity of sweepstakes entries being based at least in part on the value of the product; and
(b) a ticket dispenser for dispensing a user ticket to a user correlated with the user account, the user ticket being associated with the product through information recorded on the user ticket, the user ticket also being printed with a respective indicia for each respective sweepstakes entry associated with the user account.

18. The system of claim 17 further including a printer associated with the ticket dispenser, the printer for printing the respective indicia for each respective sweepstakes entry.

19. The system of claim 17 wherein the user account is associated with the one or more sweepstakes entries in response to a product purchase request.

20. The system of claim 17 wherein the ticket dispenser is also for recording information on the user ticket through which the user ticket is associated with the product, the recording being performed in response to a product purchase request.

21. The system of claim 17 further including a sweepstakes controller for assigning a respective sweepstakes entry record to the user account for each respective one of the one or more sweepstakes entries to the user account, each respective sweepstakes entry record being assigned randomly from a set of sweepstakes entry records.

22. The system of claim 17 further including a display terminal for receiving a sweepstakes entry reveal command and causing a display device associated therewith to produce a graphic sweepstakes entry result presentation in response to the sweepstakes entry reveal command.

23. The system of claim 22 wherein the display terminal is also for providing the product to the user.

24. The system of claim 23 wherein the product comprises Internet access.
